(19) United States
(12) Patent Application Publication
(10) Pub. No.: US 2005/0105080 A1
(43) Pub. Date: May 19, 2005

(54) Fluorometer

(76) Inventor: Richard Landlinger, Grossgmain (AT)

Correspondence Address: Marc Karish;Sheldon & Mak, 9th Floor, 225 South Lake Avenue, Pasadena, CA, 91101, US

(21) Appl. No.: 10/491,730

(22) PCT Filed: May 23, 2002
(86) PCT No.: PCT/AT02/00157

(30) Foreign Application Priority Data
May 23, 2001 (AT) A 818/2001

(51) Int. Cl. G01N 21/64; G01N 21/00

(52) U.S. Cl. 356/73; 356/417

(57) ABSTRACT

A fluorometer with at least one light source, a measuring station with a holder for at least one specimen, a measuring head, and an evaluation station with a detector for evaluating emission signals emitted by a specimen. The measuring head is formed by three optical blocks (A, B, C) assembled in a modular manner. A different measurement method is able to be carried out with each optical block (A, B, C). All the optical blocks (A, B, C) operate the same detector.

### CROSS REFERENCE TO RELATED APPLICATIONS

The present invention claims priority of PCT Application No. PCT/AT02/00157 filed on May 23, 2002, which claims priority of Austrian Patent Application No. A818/2001, filed on May 23, 2001, the entire contents of which are hereby incorporated herein by reference.

### BACKGROUND OF THE INVENTION

The invention relates to a fluorometer with at least one light source, a measuring station with a receptacle for at least one specimen container, in particular for receiving microplates and polymerase chain reaction tubes (PCR tubes), a measuring head, as well as an evaluation station with a detector, preferably a photomultiplier (PMT), for evaluating the emission signals emitted by a specimen.

A compact fluorometer measuring head module is known from U.S. Pat. No. 6,084,680 which can be used only for one measurement method (without modification). No time-resolved fluorometry, photometry, luminometry or polarization fluorometry can be measured with this apparatus.

EP 0 886 136 A1 shows an instrument for cuvettes and for measuring flash fluorometry. The detector is blinded if the flash energy is too intense as the photosensitive layer of the detector is damaged. Two flashlamps with different energy levels are therefore used.

WO 01/35079 A1 describes a fluorometer with a thermal cycler, i.e. the specimens are heated up and cooled down very intensely and rapidly. The light source is a light-emitting diode with a very limited optical spectrum and energy. This apparatus is designed for only one application.

### SUMMARY

The object of the invention is to improve a fluorometer of the type initially mentioned in order that it can be easily adapted to various requirements.

The object according to the invention is achieved in that the measuring head is formed by at least two, preferably three, optical blocks assembled in a modular manner, a different measurement method being able to be carried out with each optical block and all optical blocks operating the common detector.

Due to the modular assembly, devices for various measurement methods can be easily omitted or added. Only the parts needed for fluorometry read from above (top-reading fluorometry) are required for the base unit. All other parts can be added in a modular manner as required.

### BRIEF DESCRIPTION OF THE DRAWINGS

An embodiment of the invention will now be described in conjunction with the attached drawings where:

FIG. 1 is a front view of a fluorometer according to the invention;

FIG. 2 is a top view of a fluorometer according to the invention;

FIG. 3 is a diagram of the fluorometer configured for fluorometry from above and for polarization fluorometry;

FIG. 4 is a diagram of the fluorometer configured for fluorometry from below;

FIG. 5 is a diagram of the fluorometer configured for delayed measurement (time-resolved fluorometry);

FIG. 6 is a diagram of the fluorometer configured for photometry;

FIG. 7 is a diagram of the fluorometer configured as a luminometer; and

FIG. 8 is a diagram of a polarization filter wheel.

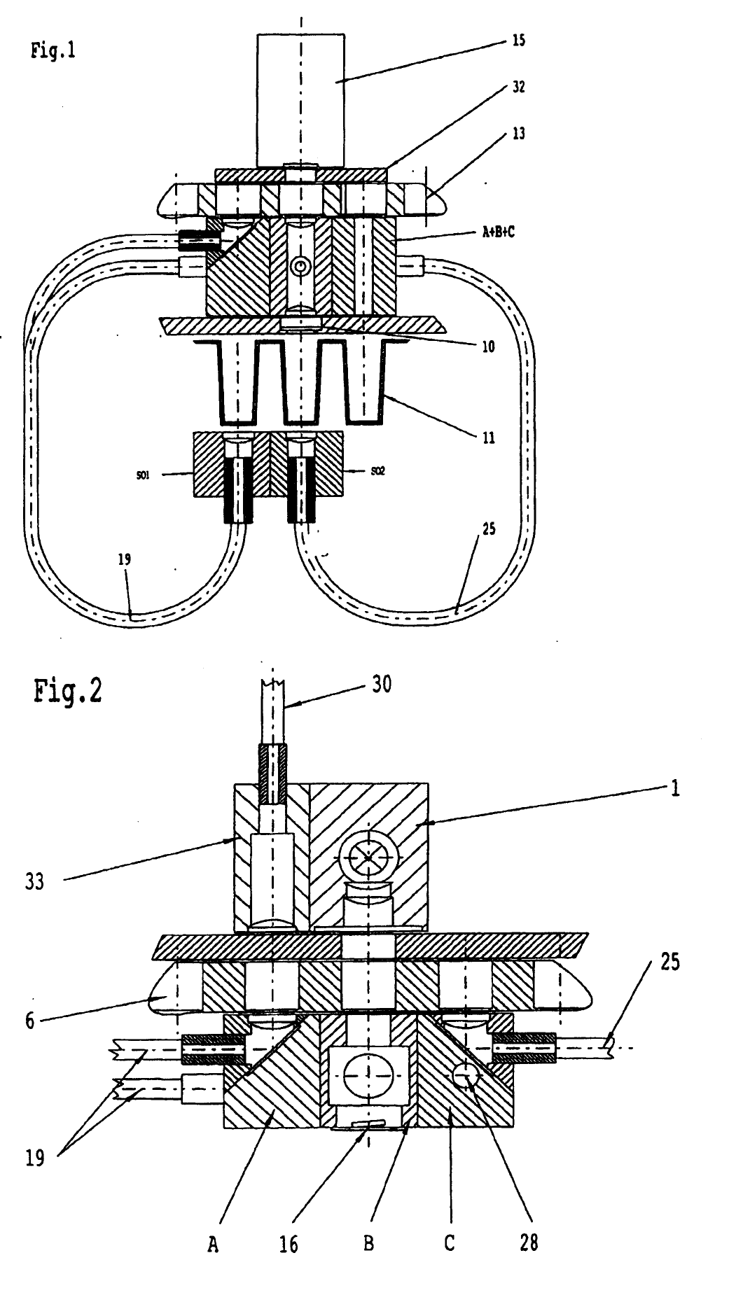

### DETAILED DESCRIPTION

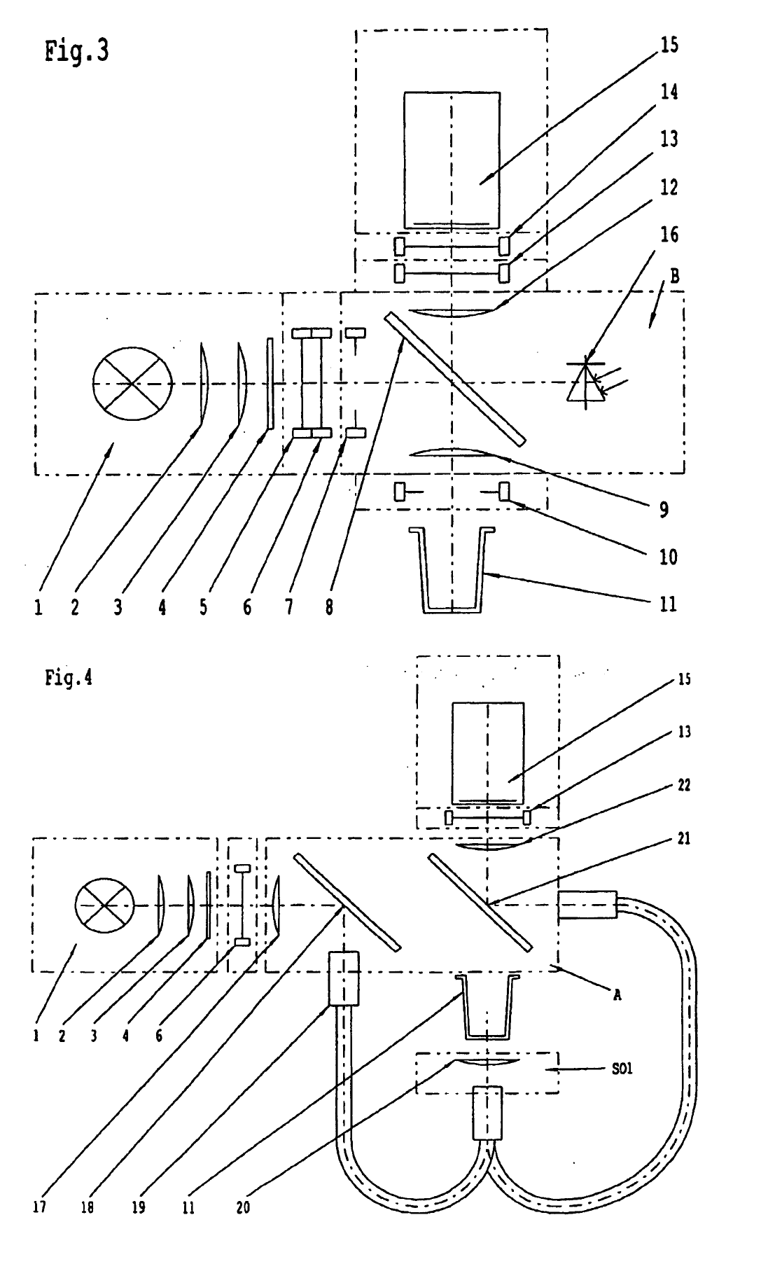

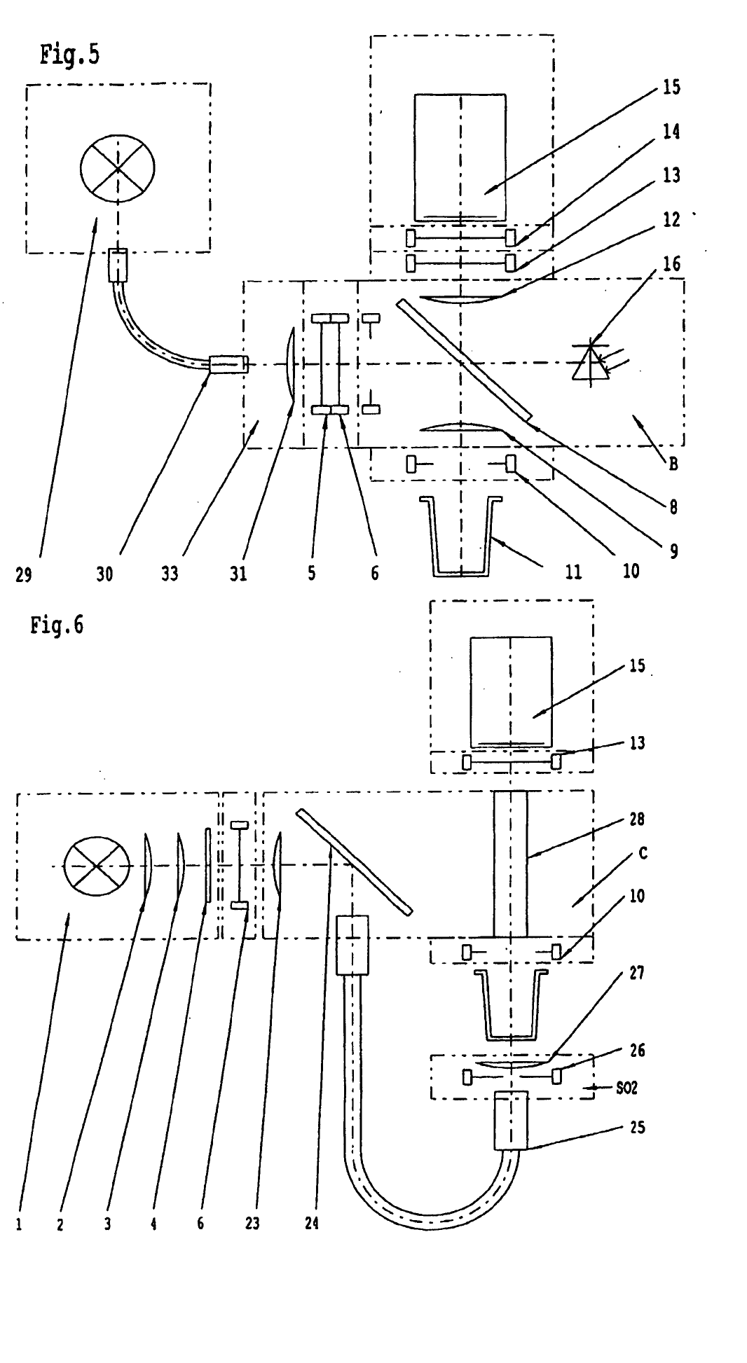

The basic equipment for all measurement methods consists of a detector 15 in the form of a photomultiplier PMT, optical block (B), first and second filter slides 6, 13 and a light source 1. Optical block B is used for fluorometry measured from above, i.e. for top-reading fluorometry and for time-delayed fluorometry (time-resolved fluorometry). A first light source 1 (FIG. 3, 4) consists of a halogen lamp with six volts and 20 watts without UV stop, two lenses 2, 3 made of non-fluorescent quartz glass, and a heat-protection glass 4 for the suppression of parasitic infrared radiation in a self-contained lamp block. The first light source 1 is used for fluorescence measurement from above and from below and for photometry. The first light source 1 is rigidly connected to a light guide holder 33 for a second light source 29 (FIG. 5) which preferably is formed by a xenon flashlamp and has a motor drive. The light source 1 and the light guide holder 33 can thus be changed automatically.

Optical block B (FIG. 5) has a supporting block made of black-anodized aluminum in which a diaphragm 7 (FIG. 3) for limiting marginal rays is arranged, as well as a broadband beam splitter 8 arranged at an angle of 45° to the light sources 1, 33 or to the specimen 11. Through this arrangement of the broadband beam splitter 8, the excitation light is diverted to the specimen and the returning fluorescence light is forwarded from the specimen 11 to the detector 15. Also provided are an output lens 9 made of non-fluorescent quartz glass (SQ 1) which focuses the beam to and from the specimen 11, a photodiode 16 for synchronizing a flash emitted by a flashlamp of the second light source 29, and optionally for monitoring the halogen lamp, as well as a lens 12 (SQ1) which guides a return beam from the specimen 11 to the detector 15 through an emission filter 13, which is formed by a filter slide 13.

Attention must be paid in particular to freedom from reflection in the region of the photodiode 16. The photodiode 16 is mounted diagonally to the light beam to prevent a retroreflection. The area surrounding the photodiode 16 is kept matte black, as otherwise the sensitivity is reduced. Optical blocks A, B, and C are rigidly connected to each other and can be selected with a motor drive.

Optical block A (FIG. 4) is used for fluorometry measurement from below. Like optical block B, optical block A has a supporting block made from black-anodized aluminum which is rigidly connected to the supporting block of optical block B. The coupling optic SO1 in turn has a distance of 18 mm to SO2 or from the upper measuring head and serves to couple and decouple the light guide 19. The coupling takes place in each case via a lens 22, 17, 20 (SQ 1) in order to focus the beam on the light guide entry area. The distance of 18 mm was chosen in order to have a uniform grid, as the grid spacing for microplates with 96 cavities is 9 mm and a better timing for all the various measurement methods is facilitated by uniform distances. The time slot pattern for many measurements is very important, e.g. fluorometry measured from above can be carried out with injection in the same time slot pattern (injection to measurement) as fluorometry measured from below. The geometric misalignment (18 mm) of the two optics for measurement from above and from below also prevents a reciprocal influencing of the optics. Aluminum surface mirrors 18, 21 serve to deflect the light beam by 90°, whereby a very compact structure is achieved, which is needed in order to have injection positions in the immediate vicinity which are required for time-critical measurement methods.

Optical block C (FIG. 6) is used for photometry, glow luminescence, and flash luminescence. Optical block C also has a supporting block made from black-anodized aluminum rigidly connected to the supporting block of optical block B. The coupling of the light beam for photometry takes place exactly as in optical block A, via the lens 23 and the mirror 24 into the light guide 25.

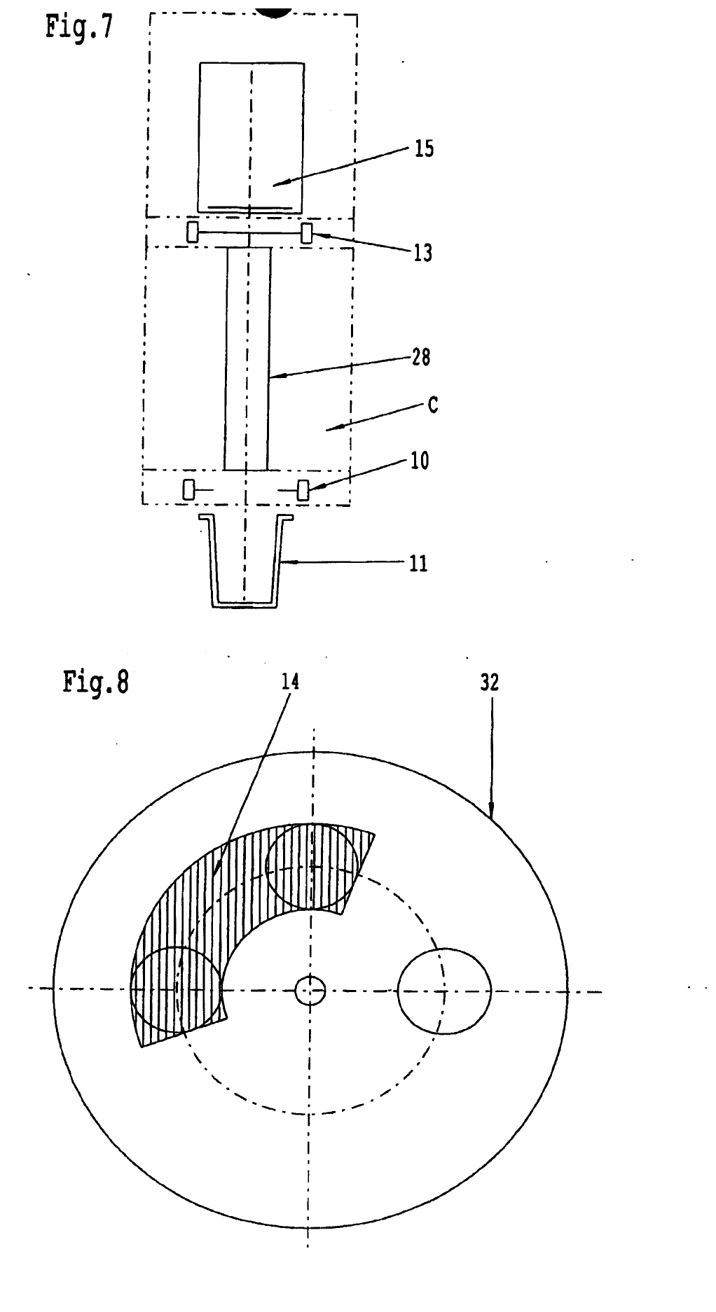

In the case of luminescence measurement and photometry, as shown in FIG. 7, the light beam from the specimen 11 is forwarded via a quartz light guide rod 28 to keep the losses for luminometry as small as possible. From the output of the quartz light guide rod 28, the light beam either travels directly to the detector 15 or via a filter slide 13 to the detector 15. The filter slide 13 is provided for wavelength-specific luminescence measurements or photometer measurements.

The second light source 29 (FIG. 5) consists of a xenon flashlamp together with a trigger mechanism, a liquid light guide 30, which among other things serves to geometrically stabilize the flash, the light guide holder 33 made of black-anodized aluminum, and an uncoupling optic formed by a lens 31.

The light sources 1, 29, i.e. the halogen lamp and the xenon flashlamp, are each positioned according to the measurement method. The distance between the two uncoupling optics of the light source 1 and the light guide holder 33 is 18 mm. The positioning of the light source 1 and the light guide holder 33 is carried out by means of a stepping motor. A guide made of black-anodized aluminum with a 9 mm (10 mm) optic opening is provided for the separation between the light source 1 and the light guide holder 33, and the filters.

The EM filters (fluorometry emission filters) for time resolved fluorometry and flash luminescence, the polarization filters 5, and the photometer filters can be installed in the first filter slide 6. The first filter slide 6 is easily removable and the filters can easily be refitted (filter sizes approx. 12.7 mm). The first filter slide 6 is driven by a stepping motor. The filters are arranged in a grid spacing of 18 mm.

Additionally, the EM filters for time resolved fluorometry and flash luminescence, the photometer filters and the luminescence filters can be installed in the second filter side 13. Like the first filter slide 6, the second filter slide 13 is easily removable, in order that the filters can be easily refitted. The filter size is again approx. 12.7 mm. The second filter slide 13 is driven by a stepping motor and the individual filters are arranged in a grid spacing of 18 mm. The first and second filter slides 6, 13 are mechanically coded to prevent confusion.

The detector 15 is a high-speed front-window photon multiplier for counting modules (high-speed front-window counter) photomultiplier with optional Peltier cooling for higher sensitivity even in the red range of the spectrum. The cooling reduces the thermal-agitation noise of red-sensitive photomultipliers. A pre-amplifier counter, with approx. 500 MHz bandwidth, which can synchronize the flashlamp directly with the counter, is used as a receiver circuit. A photon multiplier which exploits the principle of the channel electron multiplier (CEM) (channel photomultiplier) can also optionally be used.

An iris diaphragm 10 is continuously adjustable (typically 0.6 mm to 7 mm) by a motor. Various specimen sizes can therefore be measured without neighboring channel influence. A geometric scanning of the specimens is also possible (pattern recognition) as the specimen supporting transport has a step resolution of 0.1 mm in full step or correspondingly smaller in micro step operation as well as in the X and the Y direction.

The specimen coupling optic SO1 for fluorescence measured from below is arranged in a block made of matte black-anodized aluminum that holds the fluorometer light guide 19. The specimen coupling optic SO1 for fluorescence measured from below is 18 mm away from the measuring position for fluorescence measured from above in order to prevent reciprocal influencing. The fluorometer light guide 19 is twice the focal length from the lens 20.

The fluorometer light guide 19 has two optical arms, i.e. emission light guide fibers and excitation light guide fibers. The emission light guide fibers and the excitation light guide fibers are bundled in a statistical mixing ratio of 1:1. During processing, attention must be paid in particular to maximum transmission and intactness of the light guide fibers, as otherwise an increased penetration could result, and this would have a negative effect on the sensitivity of the measuring system. Furthermore, only materials which have no self-fluorescence may be used.

The overall optical structure which is to be found above the specimen 11 (i.e. optical blocks A, B, C, the light sources 1 and 29, the iris diaphragm 10, the detector 15, the polarization filters 5 and the filter slides 6, 13) can be adjusted to the respective specimen carrier height by means of a motor drive. This increases sensitivity and reduces the reciprocal influencing of neighboring specimens. This is particularly important in the case of glow luminescences, as the specimens can continue to glow for a very long time. Height adjustment is possible between approx. 10 mm and 25 mm of specimen height.

The photometer secondary optic SO2 (FIG. 6) includes a light guide 25 which has the task of bringing light under the specimen 11. The optic must prepare a very thin beam in order to be able to also measure even small specimens 11. The beam travels through the light guide 25 which is arranged in a black plastic tube 26 with an internal thread. The plastic tube 26 blocks troublesome marginal rays and acts as a sequence of many diaphragms. An output lens 27 prepares the beam in such a way that good measurement results are achieved even when there is marked meniscus formation in the specimen 11.

The system can be equipped with up to four injectors (in order to start/stop etc, the reactions). It must be borne in mind that these positions are in the immediate vicinity of the measuring positions. Rapid transport of the specimen 11 from the injector position to the measuring position is absolutely necessary in the case of various measurement methods. Injector positions are in each case 18 mm away from the measuring position for measurement from above or from the measuring position for measurement from below. In each case, two injectors can be attached in each position. In the case of equipment which injects directly in the measuring position, the measuring optic is very prone to contamination.

In order to measure fluorescence polarization, a polarization filter 14 (FIG. 5) can optionally be integrated between the second filter slide 13 and the detector 15 developed as a photomultiplier or between optical block B and the second filter slide 13. The polarization filter 14 can be rotated by a motor, and the polarization shift in the specimen 11 can thus be measured. The polarization filter wheel 32 (FIG. 8) has a position for normal measurements (9 mm bore) and an arc of 90°+beam diameter, where a polarization filter 14 is inserted. Through the rotation of the polarization filter wheel, a polarization rotation of 90° can take place. The polarization filter wheel 32 is driven by a stepping motor. A back calculation of the polarization rotation is thus easily possible. Polarizing fluorescence filters or polarization filters and interference filters must be integrated in the first filter slide 6 for the measurements.

The following is a description of the individual measurement methods. FIG. 3 is a diagram of a system for measuring fluorometry from above. The first light source 1, the first filter slide 6, optical block B, the iris diaphragm 10, the second filter slide 13 and the detector 15 developed as a photomultiplier are used for this measurement method. For this measurement method, the corresponding energy values for the respective filter combination can be set and checked (beginning and end of the measurement) via reference specimens which are integrated in the specimen carrier plate. This maintains better reproducibility and the ageing or the drift of the first light source 1 or other optical components such as the filter or the detector 15 can be compensated for.

FIG. 5 is a diagram of a system for measuring time-resolving fluorometry. The second light source 29, a liquid light guide 30, a light guide holder 33, the first filter slide 6, optical block B, the iris diaphragm 10, the second filter slide 13, a reference diode 16 and the detector 15 developed as a photomultiplier are used for this measurement method. Also for this measurement method, the corresponding energy values for the respective filter combination can be set and checked via reference specimens which are integrated in the specimen carrier plate. This also results in better reproducibility and the ageing of the xenon flashlamp of the second light source 29 or other optical components, such as filter(s) and detector(s) 15, can be compensated for. The ignition points of the second light source 29 (flashlamp) are measured with the reference photodiode and passed, synchronized via an adjustable time-resolving element, to the detector developed as a photomultiplier. The measurement window and the time-resolving window are freely programmable.

FIG. 4 is a diagram of a system for measuring Fluorometry from below. The first light source 1, the first filter slide 6, optical block A, the fluorometer light guide 19, the bottom-reading secondary optic SO1, the second filter slide 13 and the detector 15 are used for this measurement method. In this measurement method, the specimen 11 is measured from below. The corresponding energy values for the respective filter combination can be set and checked via the reference specimens which are integrated in the specimen carrier plate. This is the same procedure as is used in the case of fluorometry measurement from above.

FIG. 6 is a diagram of a system for measuring Photometry. For this measurement method, the first light source 1, the first filter slide 6 or the second filter slide 13, optical block C, the photometer secondary optic SO2 with the light guide 25, and the detector 15 are used. This measurement is a so-called flash method, i.e. the specimen 11 is lit from below with a light beam and measured from above. The iris diaphragm must be open for the measurement in order that all of the light which passes through the specimen 11 is caught and no distortion of the measuring results occurs due to different meniscus formations in the specimens 11. Lamp energy measurements are carried out at the beginning and end of each row (or column). This allows the lamp drift to be back-calculated by software and the measuring results to be improved. Furthermore, a reference channel can be dispensed with.

FIG. 7 is a diagram of a system for measuring luminometry. For this measurement method, optical block C, the iris diaphragm 10, the detector 15 developed as a photomultiplier, and preferably the second filter slide 13 are used. The specimen 11 is measured from above in this measurement. As the specimen 11 emits light for a long period in the case of different methods, it is very important to suppress cross-talk from other specimens. This is achieved by adjusting the height to the specimen 11 and by adjusting the variable iris diaphragm 10. For special applications, special luminescence filters can be used in the second filter slide 13.

Polarization fluorometry can take place according to two methods. In a first polarization measurement method, as shown in FIG. 3, the first light source 1, the filter slide 6, optical block B, the iris diaphragm 10, the second filter slide 13, a first polarization filter 5, a second polarization filter 14, and the detector 15 are used. Also in this measurement method, the corresponding energy values for the respective filter combination can be set and checked via reference specimens which are integrated in the specimen carrier plate. This results in better reproducibility and the ageing of the lamp of the first light source 1 or other optical components such as filter(s) or detector(s) 15 can be compensated for.

During integration, attention need not be paid to the precise rotation or justification of the polarization filters 5, 14. Through the rotatability of the second polarization filter 14, the 0° point (fully open) or the 90° point (fully closed) of the two polarization filters 5, 14 relative to each other can be discovered, and the polarization filters are thus automatically adjusted via an integrated reference specimen in the holder of the measuring specimens (plate slide) in the apparatus. During measurement, the polarization of the receiver side can be changed.

In a second polarization measurement method, the second light source 29, the filter slide 6, optical block B, the iris diaphragm 10, the filter slide 13, the first polarization filter 5, the second polarization filter 14 and the detector 15 are used. Also in the case of this measurement method, the corresponding energy values for the respective filter combination can be set and checked via reference specimens which are integrated in the specimen carrier plate. Also as in the preceding method, the polarization of the receiver side can be changed during the measurement. This method has the advantage that polarization fluorescence can also be measured in the UV range. However, the measurement is slower as no constant light is present. The second light source 29 is, as already mentioned, formed by a xenon flashlamp with a maximum of 1000 Hz.

Fluorescence methods and photometer methods can also optionally be carried out with the second light source 29, i.e. with a flashlight, which allows deep UV measurements but influences the measurement speed or the measurement accuracy (photometric DNA measurements at e.g. 260/280 NM).

1-16. (canceled)

17. A measuring apparatus comprising:
at least one light source;
a sample holder;
a measuring head; and
a detector;
wherein the measuring head is formed by at least two modular optical blocks, each optical block being used for another measuring method;
each optic block is used in conjunction with the detector.

18. The measuring apparatus of claim 17 wherein the at least one light source comprises at least two different selectable light sources.

19. The measuring apparatus of claim 18, wherein one light source is a halogen bulb and another light source is a photo-flash lamp.

20. The measuring apparatus of claim 18, wherein the optical blocks are moveable by an electric motor to selectively place one of the optical blocks before a selected light source.

21. The measuring apparatus of claim 20, wherein each of the at least two optical blocks further comprises a mirror, the mirror reflecting a portion of light from the selected light source by 90 degrees.

22. The measuring apparatus of claim 21, wherein the mirror of at least one of the at least two optical blocks is a beam splitter.

23. The measuring apparatus of claim 17, further comprising a polarization filter positioned between the at least two optical blocks and the detector.

24. The measuring apparatus of claim 23 wherein the polarization filter further comprises a motorized wheel of multiple different polarization filters.

25. The measuring apparatus of claim 17 wherein the at least one light source further comprises a halogen lamp; and wherein the at least one light source is moveable on a guide.

26. The measuring apparatus of claim 17, further comprising an iris screen positioned between the sample holder and the optical blocks.

27. The measuring apparatus of claim 26, wherein the iris screen is adjustable by an electric motor.

28. The measuring apparatus of claim 17, further comprising a filter slide positioned between the at least one light source and the optical blocks.

29. The measuring apparatus of claim 17, further comprising three optical blocks.

30. The measuring apparatus of claim 29 wherein two optics blocks are usable for fluorometry and one optic block is usable for photometry.

31. The measuring apparatus of claim 29 wherein each optical block is equipped with a coupling optic for coupling a light beam emitted by the at least one light source.

32. The measuring apparatus of claim 29 wherein the height of the optical blocks relative to the sample holder is adjustable by a motor.
